(19) United States
(12) Patent Application Publication
(10) Pub. No.: US 2025/0251324 A1
(43) Pub. Date: Aug. 7, 2025

(54) WELL PLATE WITH HOLLOW ELECTRODES FOR BIOSPECIMEN SAMPLE PREPARATION

(71) Applicant: BROWN UNIVERSITY, Providence, RI (US)

(72) Inventors: Ramisa Fariha, Providence, RI (US); John Murphy, Providence, RI (US); Anubhav Tripathi, Providence, RI (US)

(21) Appl. No.: 19/039,057

(22) Filed: Jan. 28, 2025

Related U.S. Application Data
(60) Provisional application No. 63/627,846, filed on Feb. 1, 2024.

(51) Int. Cl. G01N 1/40; B01D 11/02; G01N 30/02; G01N 30/72; H01J 49/00

(52) U.S. Cl. CPC G01N 1/40; B01D 11/0211; B01D 11/0215; B01D 11/0288; G01N 30/7233; H01J 49/004; G01N 2001/4038; G01N 2030/027

(57) ABSTRACT

Preparation of biospecimens for analysis is discussed. One example is a system that includes a sample well having an open top and configured to contain the biospecimen and a volume of an extraction solvent. The system also includes a bottom electrode. At least a portion of the bottom electrode is arranged in a bottom portion of the sample well opposite the open top. The system additionally includes a top electrode having an opening configured to allow material to pass through the top electrode into or out of the sample well. At least a portion of the top electrode is configured to be contained within a top portion of the sample well adjacent to the open top. The bottom electrode and the top electrode are configured to apply a voltage across the biospecimen and the volume of the extraction solvent to generate a supernatant.

### FIELD

The present technology is generally related to preparation of biological specimens such as dried blood spot (DBS) samples for analysis.

### BACKGROUND

Metabolomics is the comprehensive metabolites and small molecules in a biological specimen (“biospecimen”). Determining the metabolomics of a biospecimen (or the presence/concentration of one or more analytes) is relevant in connection with therapeutic drug monitoring, among other applications. Most metabolomics studies utilize larger sample volumes (e.g., greater than 100 μL).

### SUMMARY

The techniques of this disclosure generally relate to preparation of biospecimens, including microsamples such as dried blood spot (DBS) samples, for analysis using an electric field. Examples apply an electric field across the biospecimen and an extraction solvent to generate a supernatant for metabolomics analysis, although the technology is applicable for sample preparation of genomics (DNA) and transcriptomics (RNA).

In one aspect, the present disclosure provides a system for preparing a biospecimen to be analyzed in connection with one or more analytes. The system includes a sample well having an open top and configured to contain the biospecimen and a volume of an extraction solvent. The system also includes a bottom electrode. At least a portion of the bottom electrode is arranged in a bottom portion of the sample well opposite the open top. The system additionally includes a top electrode having an opening configured to allow material to pass through the top electrode into or out of the sample well. At least a portion of the top electrode is configured to be contained within a top portion of the sample well adjacent to the open top. The bottom electrode and the top electrode are configured to apply a voltage across the biospecimen and the volume of the extraction solvent to generate a supernatant wherein the analytes and molecules of interest will be present post-electricity application.

In another aspect, the disclosure provides a method for preparing a biospecimen to be analyzed in connection with one or more analytes. The method includes placing a biospecimen in a sample well. At least a portion of a bottom electrode is arranged in a bottom portion of the sample well. The method also includes adding a volume of an extraction solvent to the sample well. The method additionally includes producing a supernatant by generating an electric field in the volume of the extraction solvent and the biospecimen via a voltage applied for a period of time across the bottom electrode and a top electrode. At least a portion of the top electrode is arranged in a top portion of the sample well. The method further includes collecting the supernatant from the sample well.

In other aspects, the disclosure provides a non-transitory machine-readable medium having machine executable instructions for a biospecimen preparation system that causes a processor core to execute operations. The operations include placing a biospecimen in a sample well. At least a portion of a bottom electrode is arranged in a bottom portion of the sample well. The operations also include adding a volume of an extraction solvent to the sample well. The operations additionally include producing a supernatant by generating an electric field in the volume of the extraction solvent and the biospecimen via a voltage applied for a period of time across the bottom electrode and a top electrode. At least a portion of the top electrode is arranged in a top portion of the sample well. The operations further include collecting the supernatant from the sample well.

The details of one or more aspects of the disclosure are set forth in the accompanying drawings and the description below. Other features, objects, and advantages of the techniques described in this disclosure will be apparent from the description and drawings, and from the claims.

### BRIEF DESCRIPTION OF DRAWINGS

FIG. 1A is a diagram of a first example system for preparing a biospecimen to be analyzed in connection with one or more analytes (singular well).

FIG. 1B is a top perspective diagram of one example shape of a hollow top electrode of a system for preparing a biospecimen to be analyzed in connection with one or more analytes.

FIG. 2 is a diagram of a first example system for preparing a set of biospecimens to be analyzed in connection with one or more analytes.

FIG. 3 is the concentration by area for five analytes from samples prepared according to multiple techniques.

FIG. 4 illustrates a flowchart of an example method for preparing a biospecimen for analysis.

FIG. 5 is a schematic block diagram illustrating an example system of hardware components capable of implementing examples of the systems and methods disclosed herein.

### DETAILED DESCRIPTION

Various examples utilize an electric field applied across a biospecimen (e.g., dried blot spot (DBS), serum etc.) in an extraction solvent to prepare the biospecimen for analysis, such as via Liquid Chromatography tandem Mass Spectrometry (LC-MS/MS), an analytical technique combining the physical separation capabilities of liquid chromatography with the mass analysis of an MS (tandem MS refers to the mass spectrum raised to the power n). Examples employ a hollow top electrode through which the biospecimen, extraction solvent, and supernatant generated via application of the electric field are able to pass. Examples prepare biospecimens for analysis in substantially reduced time than other techniques and in a manner able to be automated.

Most metabolomics studies utilize larger sample volumes (e.g., greater than 100 μL), posing accessibility issues for early-stage disease diagnosis and monitoring in limited-resource settings. Microsamples (e.g., minute samples such as ≤100 μL for blood and 50 μL for others) have been used for some metabolomic and other analysis, but the available sample preparation techniques for microsamples are long (e.g., 30 minutes or longer) and not automatable for large-scale clinical application. Examples of microsamples include DBS, serum, tissue, plasma, urine, saliva, ear wax, dried fecal spot, etc. While DBS samples are discussed in connection with several specific examples, various examples are useable in preparing any of a variety of biospecimens for analysis. Any of a variety of analytical techniques are useable in connection with various examples, such as via LC-MS/MS.

While DBS samples are relatively easy to collect, transport, and store, preparation of DBS samples for analysis is time consuming and involves multiple steps performed by a trained professional. A variety of sample preparation techniques are available, such as solid-phase extraction, liquid-liquid extraction, or combination reactions. Depending on the specific technique, sample preparation involves addition of an extraction solvent to the DBS sample (e.g., a punch or sub-punch from a DBS), mixing/shaking of the solution, sonication and/or centrifuging of the solution, and collection of the resulting supernatant for analysis. The total preparation time can vary based on the sample preparation technique and is typically 30 minutes or more per DBS sample.

In contrast to other sample preparation techniques (e.g., with or without sonication), various examples prepare biospecimens for analysis (e.g., via LC-MS/MS) in a substantially reduced time (e.g., around 3 minutes) and in a manner that can be automated, as the hollow top electrode of various examples allows a pipette tip of a robotic liquid handler to extend into and/or through the hollow top electrode to add or more material from a sample well. Various examples apply an electric field to the solution formed via addition of the extraction solvent to the biospecimen, after which a supernatant (e.g., with equal or greater analyte recovery than that obtained from other preparation techniques) can be collected for analysis (e.g., via LC-MS/MS). Various examples are useable as or with autonomous labware within a robotic liquid handling system (e.g., with extraction solvent able to be added to and supernatant collected from a sample well through the hollow top electrode, which can be a cylinder or any of a variety of other shapes, etc.), allowing for simultaneous preparation of a large number (e.g., 96, etc.) of DBS samples simultaneously and more quickly (e.g., 3 minutes vs. 30 minutes, etc.) than other preparation techniques. While specific examples discussed herein show a hollow electrode with a cylindrical shape for the purposes of illustration, various examples include a hollow electrode having substantially any shape that has an opening that allows a pipette tip of a robotic liquid handler to extend into and/or through the hollow top electrode to add or more material from a sample well. As a result, examples discussed herein provide a significant increase in throughput of DBS sample preparation and analysis.

The increased throughput provided by various examples enables the use of DBS and other microsamples in a wide range of scenarios (e.g., widespread use of tier-2 diagnostic assays associated with various conditions, etc.) not possible via other preparation techniques. As one example use case, in the United States, approximately one in five pregnant women self-reports opioid abuse, and in utero exposure to opioids, a consequence of maternal misuse, results in Neonatal Abstinence Syndrome (NAS), characterized by withdrawal symptoms in newborns. Current diagnostic approaches for NAS rely on visible signs, with the Finnegan Neonatal Abstinence Scoring System (FNASS) serving as the gold standard. Pharmacological treatments, often involving morphine administration, contribute to extended hospital stays for affected infants. However, challenges in obtaining biological samples from infants impede efficient NAS diagnosis. Various examples use DBS microsamples as a quantitative diagnostic material for the rapid and efficient detection of NAS in infants, enhancing diagnostic accuracy and expediting turnaround times, addressing current limitations in NAS diagnosis. Additional example use cases include diagnostics/analysis related to congenital adrenal hyperplasia (CAH), post-partum depression, research applications such as in vitro to in vivo extrapolation (IVIVE), neuroendocrine disorders such as polycystic ovarian syndrome (PCOS), profiling oncological disease progression via genomic (DNA) and transcriptomics (RNA) analysis, immunosuppressants quantification, additional neonatal screening, and/or tumoroid-on-a-chip platforms, among others.

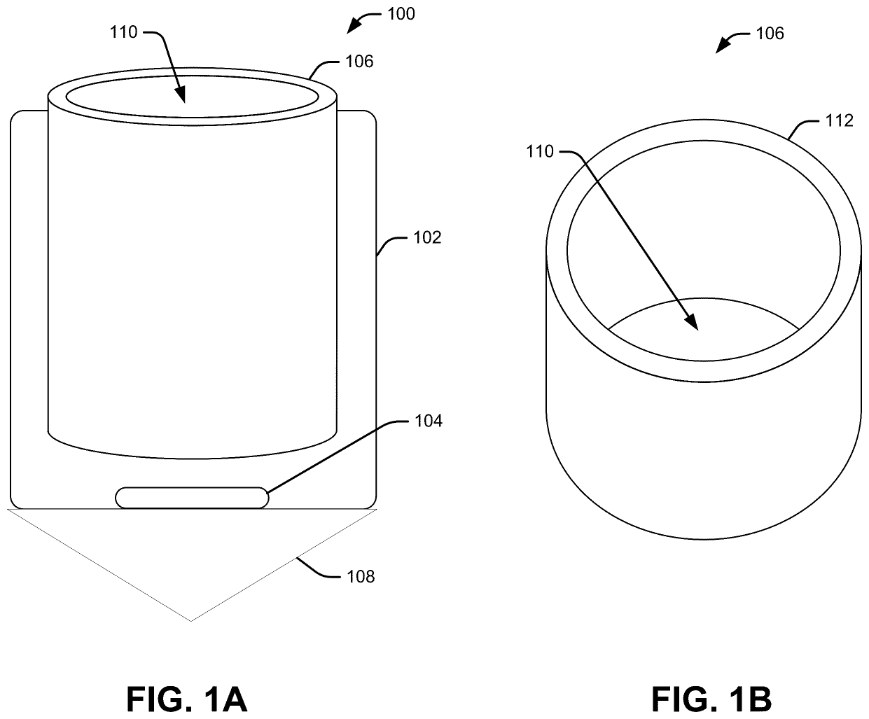

Referring to FIG. 1A, illustrated is a diagram of a first example system 100 for preparing a biospecimen to be analyzed (e.g., via LC-MS/MS) in connection with one or more analytes. The system 100 includes a sample well 102 with an open top, which can contain a biospecimen 104 to be analyzed and a volume of an extraction solvent. The system 100 also includes at least a portion of a hollow top electrode 106 and at least a portion of a bottom electrode 108. The top electrode 106 has an opening 110 that allows material to be added to or collected from the sample well 102 through the opening 110 of the top electrode 106, such as by extending a pipette tip into or through the top electrode 106 to add or remove liquid from the sample well 102.

In various examples, the sample well 102 can be a single sample well or a sample well of a well plate (e.g., for use in connection with a robotic liquid handler, etc.) that includes a plurality of sample wells arranged in an array of rows and columns, such as 96 sample wells arranged in 12 rows of 8 sample wells, etc. In some examples, the sample well 102 used can be any of a variety of existing sample wells/well plates modified to include the bottom electrode 108 or a portion thereof. In other examples, the sample well 102 is a sample well with an integrated bottom electrode 108 or a portion thereof.

For purposes of illustration, a DBS sample (e.g., a punch or sub-punch from a DBS on a DBS card, etc.) is discussed as a specific example of the biospecimen 104, although various examples are capable of preparing a variety of biospecimens 104 for analysis. As one specific example, the biospecimen 104 used in testing a prototype example was a 3.2 mm sub-punch using an automatic DBS puncher with a 3.2 mm head, obtained from the interior of a DBS on a DBS card, allowing the same DBS to be used for multiple analyses (e.g., for various analytes, etc.).

In various examples, the volume of the extraction solvent includes any of a variety of solvents or combinations of solvents, such as a combination of high-performance liquid chromatography (HPLC) water, organic solvent(s), inorganic solvent(s), and/or additives to improve electrical conductivity of the volume of the extraction solvent, added to the sample well 102 separately or in any of a variety of combinations. As one specific example, the volume of the extraction solvent used in testing a prototype example included 80 μL of 50:50 volume by volume (v/v) methanol:acetonitrile with 0.1% formic acid and 167 μL of HPLC water and 1% formic acid. In addition to potential variations in composition of the extraction solvent, the quantity added can also vary to greater or lesser values, such as based on the size of the biospecimen, the size of the sample well, the height of the portion of the top electrode 106 within the sample well 102 (e.g., a relatively taller portion of the top electrode 108 can make contact with the top surface of a wider range of volumes of the extraction solvent than a relatively shorter portion of the top electrode 108), etc.

In various examples, at least a portion of the top electrode 106 is aligned with the sample well 102 and able to move into or out of the sample well 102 to make contact with the volume of the extraction fluid. In the same or other embodiments, contact between the top electrode 106 and the volume of extraction fluid is made by adding sufficient extraction fluid to make contact with the top electrode 106. The portion of the top electrode 106 includes the opening 110 that allows material (e.g., the volume of the extraction fluid, a supernatant, and/or the biospecimen, etc.) to pass through the opening 110 into or out of the sample well 102.

In various examples wherein the sample well 102 is a sample well of a set of sample wells of a well plate (e.g., for use in connection with a robotic liquid handler, etc.), the top electrode 106 has a set of openings (e.g., such as the opening 110, etc.) corresponding to the set of sample wells, allowing material to pass through the top plate into or out of each sample well of the set of sample wells. In some examples, the top electrode 106 is configured to be used as labware for a robotic liquid handler for automated preparation of the biospecimen for analysis. In various such examples, the robotic liquid handler adds material to and/or collects material from a set of sample wells (e.g., including the sample well 102) of a well plate through a set of openings of the top electrode 106 (e.g., including the opening 110 through the portion of the top electrode 106 shown in FIG. 1, etc.). In some examples, the top electrode 106 is removable, allowing for the biospecimen 104 to be placed in the sample well 102 without the top electrode 106 being present, while in other examples the biospecimen 104 is placed in the sample well 102 through the opening 110 of the top electrode 106.

FIG. 1B illustrates a top perspective diagram of one example shape of a hollow top electrode 106 of a system (e.g., the system 100) for preparing a biospecimen to be analyzed in connection with one or more analytes. The hollow top electrode 106 of FIG. 1B has an open cylindrical shape, with a cylindrical opening 110 that extends completely through a conductive shell 112 of the hollow top electrode 106. In some examples, the portion of the top electrode 106 that aligns with the sample well is cylindrical, with a circular opening as the opening 110, such as shown in FIGS. 1A and 1i, although various shapes can be used in various examples. In various examples, the shape of the opening 110 has any of a variety of shapes (e.g., having a curved and/or regular/irregular polygonal cross-section, or combinations thereof) can be the same or different than the shape of the outer surface of the top electrode 106, and can depend on the equipment and/or materials the opening 110 is designed to accommodate (e.g., to accommodate a pipette tip, or pipette tip(s) of one or more models of robotic liquid handler, etc.). In various examples, the cross-section of the opening 110 is constant along at least a portion of the length of the opening 110 and/or varies along at least a portion of the length of the opening (e.g., varying linearly such as a truncated conical or pyramidal shape and/or nonlinearly such as paraboloid shapes, etc.). The height of the portion of the top electrode 106 that aligns with the sample well can vary between examples and can depend on the volume of the extraction fluid and the size of the sample well 102. As one specific example, the top electrode 106 used in testing a prototype example was a copper printed circuit board (PCB) with a set of holes to accommodate a set of cylindrical stainless steel spacers with a height of around ⅜th inch aligned with the set of sample wells of a well plate for use with a robotic liquid handler.

A portion of the bottom electrode 108 is arranged within a bottom portion of the sample well 102 opposite the open top of the sample well 102. In various examples, the portion of the bottom electrode 106 arranged within the bottom of the sample well 102 has a substantially flat top surface, although shapes are used in various examples. As one specific example, the bottom electrode 108 used in testing a prototype example included a set of flathead screws attached through holes in the bottom of a set of sample wells of a well plate to a copper PCB, with the top surfaces of the flathead screws serving as the top surface of the portion of the bottom electrode 108 within each sample well.

Once the volume of extraction solvent is in contact with the top electrode 106 and the bottom electrode 108, a circuit is completed from the top electrode 106, through the volume of the extraction solvent and the biospecimen 104, the bottom electrode 108, and a power supply (not shown in FIG. 1). In various examples, a voltage is applied across the biospecimen 104 and the volume of the extraction solvent between the top electrode 106 and the bottom electrode 108 for a period of time. The parameters of the applied voltage can vary between examples (e.g., based on the selected analytes for analysis, etc.), for example, in terms of the volts applied (e.g., between 10V and 50V, between 20V and 40V, between 25V and 35V, around 30V, etc.), whether a direct current (DC) and/or alternating current (AC) voltage is applied, the polarity when a DC voltage or an AC voltage with a DC offset is applied (e.g., with the top electrode 106 at a higher voltage/offset or the bottom electrode 108 at a higher voltage/offset), the frequency when AC voltage is applied (e.g., between 0.28 Hz and 11.2 Hz, between 0.56 Hz and 5.6 Hz, etc.), etc.

Additionally, the period of time during which the voltage is applied can vary between examples (e.g., 1-5 minutes, 2-4 minutes, around 3 minutes, etc.). Modeling of the electric potential of a prototype example showed that the electric potential was uniform throughout the prototype example within the first minute of the electric field application and remained uniform for the rest of the exposure time.

Application of the voltage for the period of time produces a supernatant that includes the analytes for analysis (if present in the biospecimen 104) with a concentration comparable or superior to that obtained via other preparation techniques. The supernatant can be collected from the sample well for analysis. In contrast to other preparation techniques, the system 100 and the associated preparation technique are able to be completely automated, substantially increasing throughput.

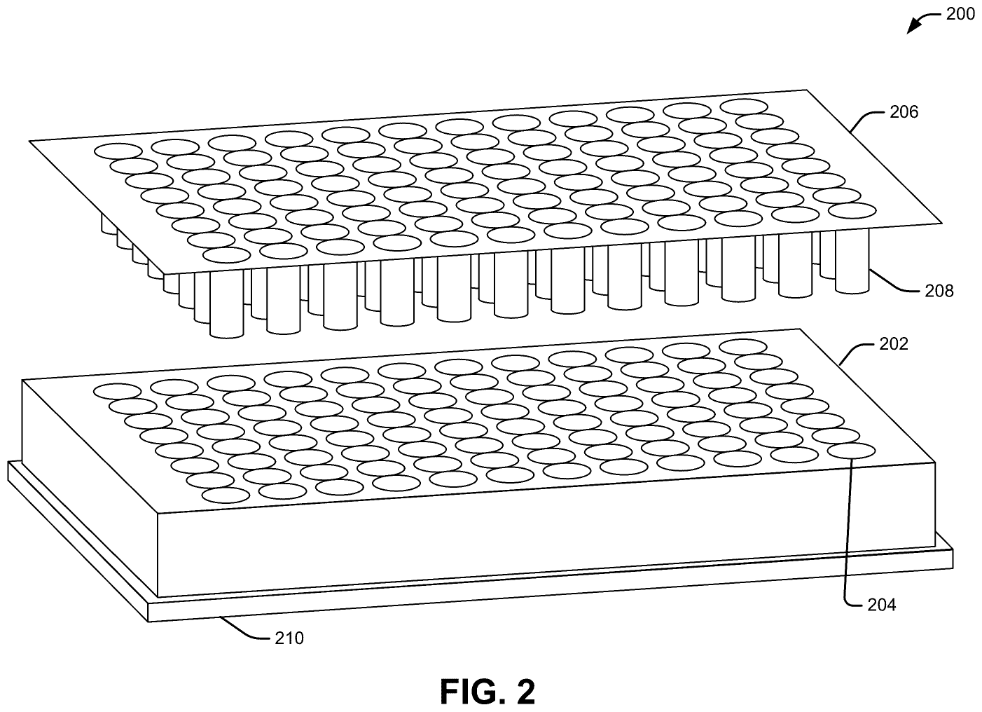

Referring to FIG. 2, illustrated is a diagram of a second example system 200 for preparing a set of biospecimen to be analyzed (e.g., via LC-MS/MS) in connection with one or more analytes. The system 200 includes a well plate 202 with a set of sample wells (96 in the example system shown in FIG. 2, although well plates with other numbers of sample wells are useable in various examples) such as example sample well 204. Atop electrode 206 includes a set of portions (e.g., hollow spacers, etc.) such as example spacer 208. The top electrode 206 has an opening (e.g., such as the opening 110 of FIG. 1, etc.) through each spacer for adding and/or collecting material from a corresponding sample well of the set of sample wells, such as through example spacer 208 into sample well 204. The well plate 202 is connected to a bottom electrode 210, which has a set of portions, with each sample well of the well plate 202 containing a corresponding portion of the bottom electrode 210. The system 200 is compatible with a robotic liquid handler, allowing for automated preparation of biospecimens in each sample well of the well plate 202. Once a volume of extraction solvent in each sample well of a set of sample wells (e.g., one or more sample wells with an associated biospecimen of a set of biospecimens in each of the one or more sample wells) of the well plate 202 is in contact with the top electrode 206 and the bottom electrode 210, a circuit is completed from the top electrode 206, through the volumes of the extraction solvent and the set of biospecimens in the set of sample wells of the well plate 202, the bottom electrode 210, and a power supply (not shown in FIG. 2). The voltage applied across the top electrode 206, the volumes of the extraction solvent, the set of biospecimens and the bottom electrode 210 simultaneously generates a supernatant in each sample well of the set of sample wells of the well plate 202. Various example systems adapted for use in connection with robotic liquid handlers can vary based on the specific robotic liquid handler. The example system 200 is provided as a specific example adapted for use on a JANUS robotic liquid handler, and example systems adapted for use on other robotic liquid handlers can vary (e.g., based on compatible well plates, etc.).

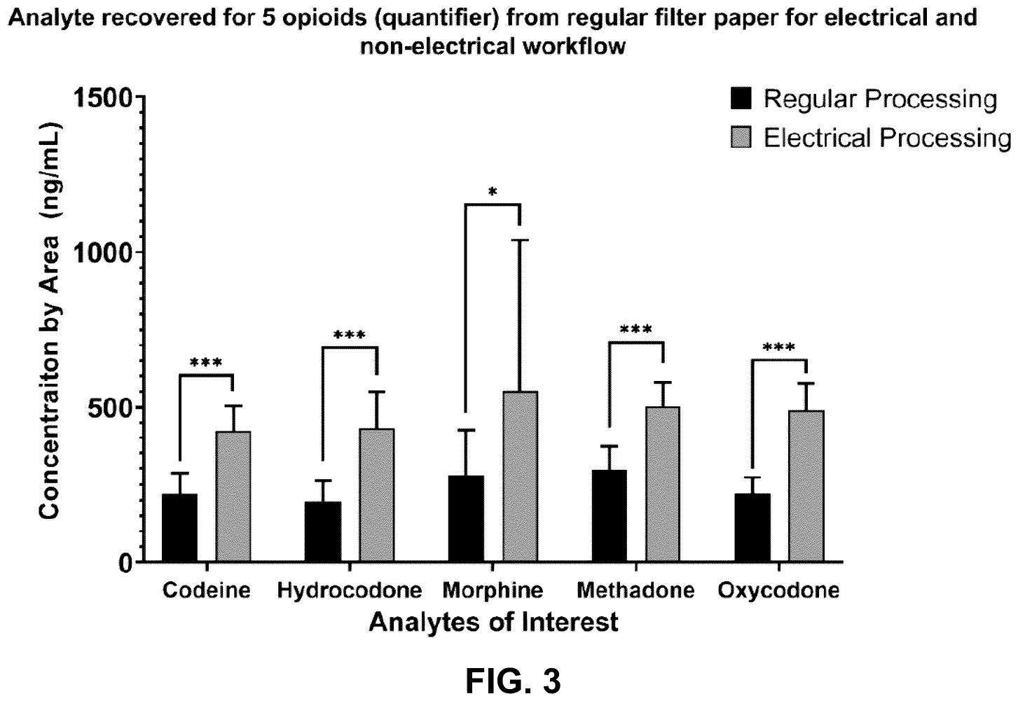

A prototype with a similar design to the example system 200 was tested in comparison with other preparation techniques, in connection with five analytes of interest related to neonatal abstinence syndrome. FIG. 3 shows a chart of the concentration by area for oxycodone, methadone, morphine, hydrocodone, and codeine from samples prepared according to existing techniques. Each pair of bars shows the mean concentration for the analyte from DBS on regular filter paper spots prepared via existing (e.g., 30 minute) techniques (left column) and via example techniques utilizing electrical processing (right column). The example techniques applied a DC voltage for three minutes, in contrast to the 30 minute preparation via the existing technique. As can be seen in FIG. 3, the example technique obtained analyte concentrations comparable to or greater than the existing technique at a substantially reduced time (3 minutes vs. 30 minutes). Additionally, the example (e.g., electric field-based) techniques are capable of automation, in contrast to existing techniques.

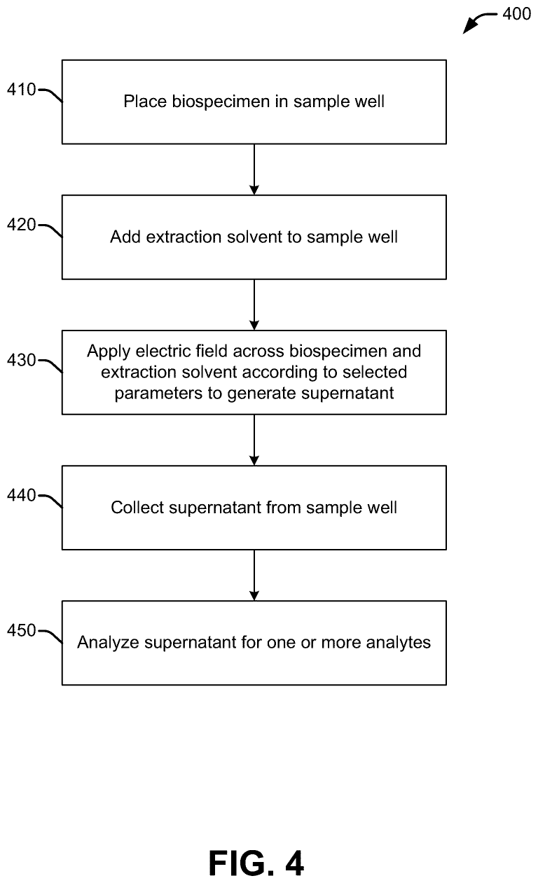

In view of the foregoing structural and functional features described above, example methods will be better appreciated with reference to FIG. 4. While, for purposes of simplicity of explanation, the example methods of FIG. 4 are shown and described as executing serially, it is to be understood and appreciated that the present examples are not limited by the illustrated order, as some actions could in other examples occur in different orders, multiple times and/or concurrently from that shown and described herein. Moreover, it is not necessary that all described actions be performed to implement a method.

FIG. 4 illustrates a flowchart of an example method 400 for preparing a biospecimen for analysis. In other examples, the blocks of example method 400 are a set of machine-readable instructions on a non-transitory machine-readable medium or are a set of operations performed by a processor executing machine-readable instructions as the operations.

At block 410, method 400 includes placing a biospecimen (e.g., the biospecimen 104, etc.) in a sample well (e.g., the sample well 102, the sample well 204, etc.). In some examples, the biospecimen is a DBS, but other biospecimens are useable in various examples. In some examples, the biospecimen is a DBS placed in a sample well via an automatic DBS puncher.

At block 420, method 400 includes adding a volume of an extraction solvent to the sample well. The composition and quantity of the extraction solvent added can vary depending on the example. In some examples, the volume of the extraction solvent is added by a robotic liquid handler.

At block 430, method 400 includes generating a supernatant by applying an electric field across the biospecimen and the volume of the extraction solvent (e.g., by applying a voltage across a top electrode 106 or 206 and a bottom electrode 108 or 210, etc.) according to selected parameters (e.g., DC and/or AC, at a selected voltage, at a selected frequency when AC, for a selected period of time, etc.).

At block 440, method 400 includes collecting the supernatant from the sample well. In various examples, the supernatant is collected by a robotic liquid handler.

At block 450, method 400 includes analyzing the collected supernatant for one or more analytes.

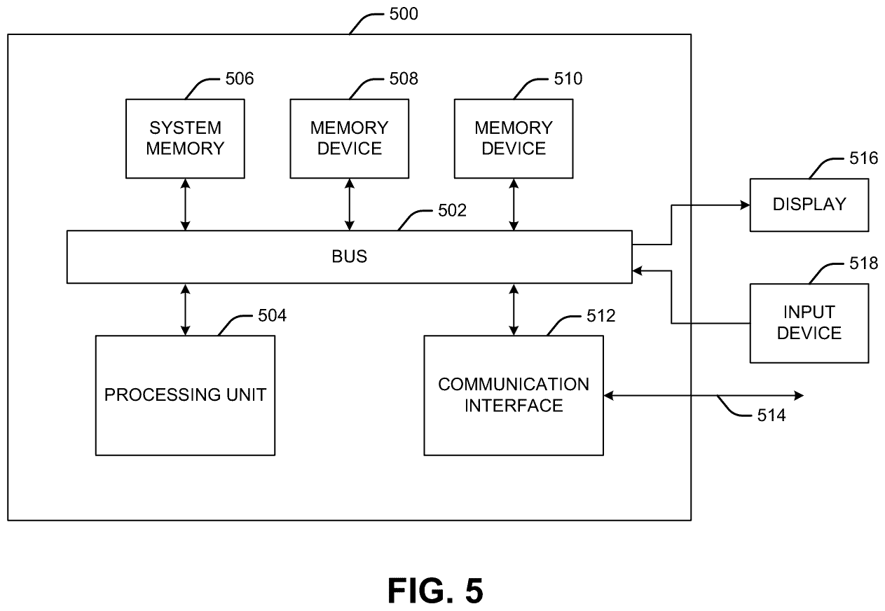

FIG. 5 is a schematic block diagram illustrating an example system 500 of hardware components capable of implementing examples disclosed herein. The system 500 can include various systems and subsystems, and in some examples is employable in connection with a robotic liquid handler (e.g., a JANUS robotic liquid handler as used in connection with the prototype example, or another robotic liquid handler, etc.) as a biospecimen preparation system. The system 500 can be a personal computer, a laptop computer, a workstation, a computer system, an appliance, an application-specific integrated circuit (ASIC), a server, a server BladeCenter, a server farm, etc.

The system 500 can include a system bus 502, a processing unit 504, a system memory 506, memory devices 508 and 510, a communication interface 512 (e.g., a network interface), a communication link 514, a display 516 (e.g., a video screen), and an input device 518 (e.g., a keyboard, touch screen, and/or a mouse). The system bus 502 can be in communication with the processing unit 504 and the system memory 506. The additional memory devices 508 and 510, such as a hard disk drive, server, standalone database, or other non-volatile memory, can also be in communication with the system bus 502. The system bus 502 interconnects the processing unit 504, the memory devices 506-510, the communication interface 512, the display 516, and the input device 518. In some examples, the system bus 502 also interconnects an additional port (not shown), such as a universal serial bus (USB) port.

The processing unit 504 can be a computing device and can include an application-specific integrated circuit (ASIC) and/or include one or more processing cores (e.g., single-core, multi-core), which in various examples include CPU(s), GPU(s), etc. The processing unit 504 executes a set of instructions to implement the operations of examples disclosed herein.

The additional memory devices 506, 508, and 510 can store data, programs, instructions, database queries in text or compiled form, and any other information that may be needed to operate a computer. The memories 506, 508 and 510 can be implemented as computer-readable media (integrated or removable), such as a memory card, disk drive, compact disk (CD), or server accessible over a network. In certain examples, the memories 506, 508 and 510 can comprise text, images, video, and/or audio, portions of which can be available in formats comprehensible to human beings. Additionally or alternatively, the system 500 can access an external data source or query source through the communication interface 512, which can communicate with the system bus 502 and the communication link 514.

In operation, the system 500 can be used to implement one or more parts of a system in accordance with examples discussed herein. Computer executable logic for implementing a biospecimen preparation system resides on one or more of the system memory 506, and the memory devices 508 and 510 in accordance with certain examples. The processing unit 504 executes one or more computer executable instructions originating from the system memory 506 and the memory devices 508 and 510. The terms “computer readable medium” or “machine readable medium” as used herein includes a medium that participates in providing instructions to the processing unit 504 for execution and in various examples includes non-transitory, volatile and non-volatile, removable and non-removable media implemented in any method or technology for storage of information such as computer-readable instructions, data structures, program modules, or other data. For example, computer-readable storage media includes RAM, ROM, EPROM, EEPROM, flash memory or other solid state memory technology, CD-ROM, DVD, Blu-Ray or other optical storage, magnetic cassettes, magnetic tape, magnetic disk storage or other magnetic storage devices, or any other medium that can be used to store the desired information and that can be accessed by the system 500. In one or more embodiments, computer-readable storage media can be stored in the cloud or remote storage and accessed using any suitable technique or techniques through at least one of a wired or wireless connection.

In various examples, one or more software programs stored in at least one of the system memory 506, the memory device 508, or the memory device 510 include instructions that are executed by the processing unit 504 to perform operations associated with the examples.

It should be understood that various aspects disclosed herein may be combined in different combinations than the combinations specifically presented in the description and accompanying drawings. It should also be understood that, depending on the example, certain acts or events of any of the processes or methods described herein may be performed in a different sequence, may be added, merged, or left out altogether (e.g., all described acts or events may not be necessary to carry out the techniques). In addition, while certain aspects of this disclosure are described as being performed by a single module or unit for purposes of clarity, it should be understood that the techniques of this disclosure may be performed by a combination of units or modules associated with, for example, a medical device.

In one or more examples, the described techniques may be implemented in hardware, software, firmware, or any combination thereof. If implemented in software, the functions may be stored as one or more instructions or code on a computer-readable medium and executed by a hardware-based processing unit. Computer-readable media may include non-transitory computer-readable media, which corresponds to a tangible medium such as data storage media (e.g., RAM, ROM, EEPROM, flash memory, or any other medium that can be used to store desired program code in the form of instructions or data structures and that can be accessed by a computer).

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor” as used herein may refer to any of the foregoing structure or any other physical structure suitable for implementation of the described techniques. Also, the techniques could be fully implemented in one or more circuits or logic elements.

In this description, unless otherwise stated, “about,” “approximately” or “substantially” preceding a parameter means being within ±10 percent of that parameter. Modifications are possible in the described embodiments, and other embodiments are possible, within the scope of the claims.

What is claimed is:

1. A system for preparing a biospecimen to be analyzed in connection with one or more analytes, the system comprising:
a sample well having an open top and configured to contain the biospecimen and a volume of an extraction solvent;
a bottom electrode, wherein at least a portion of the bottom electrode is arranged in a bottom portion of the sample well opposite the open top; and
a top electrode having an opening configured to allow material to pass through the top electrode into or out of the sample well, wherein at least a portion of the top electrode is configured to be contained within a top portion of the sample well adjacent to the open top,
wherein the bottom electrode and the top electrode are configured to apply a voltage across the biospecimen and the volume of the extraction solvent to generate a supernatant.

2. The system of claim 1, wherein the second opening is a cylindrical opening through a cylindrical portion of the top electrode.

3. The system of claim 2, wherein the cylindrical portion of the top electrode has a height of approximately ⅜th of an inch.

4. The system of claim 1, further comprising a set of sample wells that comprise the sample well and an additional sample well having an additional open top and configured to contain an additional biospecimen and an additional volume of the extraction solvent,
wherein at least an additional portion of the bottom electrode is arranged in a bottom portion of the additional sample well opposite the additional open top, and
wherein the top electrode has an additional opening configured to allow additional material to pass through the top electrode into or out of the additional sample well, and at least an additional portion of the top electrode is configured to be contained within a top portion of the additional sample well adjacent to the additional open top.

5. The system of claim 4, wherein the set of sample wells is arranged into an array comprising a set of rows and a set of columns.

6. The system of claim 5, further comprising a well plate configured for use by a robotic liquid handler, wherein the well plate comprises the set of sample wells.

7. The system of claim 1, wherein at least the portion of the bottom electrode and at least the portion of the top electrode are gold plated.

8. A method for preparing a biospecimen to be analyzed in connection with one or more analytes, comprising:
placing a biospecimen in a sample well, wherein at least a portion of a bottom electrode is arranged in a bottom portion of the sample well;
adding a volume of an extraction solvent to the sample well;
producing a supernatant by generating an electric field in the volume of the extraction solvent and the biospecimen via a voltage applied for a period of time across the bottom electrode and a top electrode, wherein at least a portion of the top electrode is arranged in a top portion of the sample well; and
collecting the supernatant from the sample well.

9. The method of claim 8, wherein the voltage is a direct current (DC) voltage.

10. The method of claim 8, wherein the voltage is at least 20 V and at most 40 V.

11. The method of claim 8, wherein the voltage is applied when the top electrode is in contact with the volume of the extraction solvent.

12. The method of claim 8, wherein the period of time is less than four minutes.

13. The method of claim 8, wherein the biospecimen is a dried blood spot (DBS).

14. The method of claim 8, further comprising:
placing an additional biospecimen in an additional sample well, wherein at least an additional portion of a bottom electrode is arranged in a bottom portion of the additional sample well;
adding an additional volume of the extraction solvent to the additional sample well;
producing an additional supernatant by generating an additional electric field in the additional volume of the extraction solvent and the additional biospecimen via the voltage applied for the period of time across the bottom electrode and the top electrode, wherein at least an additional portion of the top electrode is arranged in a top portion of the additional sample well; and
collecting the additional supernatant from the additional sample well.

15. The method of claim 14, wherein the sample well and the additional sample well are sample wells of a well plate configured for use by a robotic liquid handler.

16. The method of claim 8, further comprising analyzing the supernatant in connection with one or more analytes.

17. The method of claim 16, wherein analyzing the supernatant comprises analyzing the supernatant via liquid chromatography-tandem mass spectrometry (LC-MS/MS).

18. A non-transitory machine-readable medium having machine executable instructions for a biospecimen preparation system that causes a processor core to execute operations, the operations comprising:
placing a biospecimen in a sample well, wherein at least a portion of a bottom electrode is arranged in a bottom portion of the sample well;
adding a volume of an extraction solvent to the sample well;
producing a supernatant by generating an electric field in the volume of the extraction solvent and the biospecimen via a voltage applied for a period of time across the bottom electrode and a top electrode, wherein at least a portion of the top electrode is arranged in a top portion of the sample well; and
collecting the supernatant from the sample well.

19. The non-transitory machine-readable medium of claim 18, wherein the voltage is a direct current (DC) voltage.

20. The non-transitory machine-readable medium of claim 18, wherein the voltage is at least 20 V and at most 40 V.

21. The non-transitory machine-readable medium of claim 18, wherein the voltage is applied when the top electrode is in contact with the volume of the extraction solvent.

22. The non-transitory machine-readable medium of claim 18, wherein the period of time is less than four minutes.

23. The non-transitory machine-readable medium of claim 18, wherein the biospecimen is a dried blood spot (DBS).

24. The non-transitory machine-readable medium of claim 18, the operations further comprising:
placing an additional biospecimen in an additional sample well, wherein at least an additional portion of a bottom electrode is arranged in a bottom portion of the additional sample well;
adding an additional volume of the extraction solvent to the additional sample well;
producing an additional supernatant by generating an additional electric field in the additional volume of the extraction solvent and the additional biospecimen via the voltage applied for the period of time across the bottom electrode and the top electrode, wherein at least an additional portion of the top electrode is arranged in a top portion of the additional sample well; and
collecting the additional supernatant from the additional sample well.

25. The non-transitory machine-readable medium of claim 24, wherein the sample well and the additional sample well are sample wells of a well plate configured for use by a robotic liquid handler.

26. The non-transitory machine-readable medium of claim 18, the operations further comprising analyzing the supernatant in connection with one or more analytes.

27. The non-transitory machine-readable medium of claim 26, wherein analyzing the supernatant comprises analyzing the supernatant via liquid chromatography-tandem mass spectrometry (LC-MS/MS).
